(19) United States
(12) Patent Application Publication
(10) Pub. No.: US 2007/0056913 A1
(43) Pub. Date: Mar. 15, 2007

(54) PORTABLE OIL FIELD WASTE WATER TREATMENT AND RECYCLING SYSTEM

(76) Inventor: David C. Burt, Cleburne, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 11/464,727

(22) Filed: Aug. 15, 2006

Related U.S. Application Data
(60) Provisional application No. 60/710,029, filed on Aug. 19, 2005.

(51) Int. Cl. C02F 1/52

(52) U.S. Cl. 210/721; 210/760

(57) ABSTRACT

A method is shown for treating oil field waste waters associated with drilling, completion and production operations. An ozonation process is used as a pre-treatment to a flocculation process in the continuous treatment of oil field drilling and production reserve pit waste water. The treated water has been found to meet recycled re-use quality standards for re-use in oil field applications or to meet discharge parameters for ground disposal.

### CROSS REFERENCES TO RELATED APPLICATIONS

The present application claims priority from a provisional application, U.S. Ser. No. 60/710,029, files Aug. 19, 2006.

### BACKGROUND OF THE INVENTION

1. Field of the Invention

The present invention relates generally to waste water treatment systems for oil and gas well drilling installations and, more specifically, to the reserve pits of such installations where the cleanup process for removing undesirable waste material from the contents of the reserve pit is carried out in a continuous process.

2. Description of the Prior Art

Wells for recovering oil and gas reserves are typically created by drilling into an underground source using a hollow drill string supported in a drilling rig. The drill string includes a drill bit at the lower end that is rotated into the ground to create a well bore. As the drill bit is rotated, drilling fluid is pumped down through the interior of the drill string to pass through the bit and return to the surface in the well bore external to the drill string. The drilling fluid acts to lubricate the drill bit and carries the loose solids created by the drill bit to the surface. At the surface, the used drilling fluid is collected and recycled by removing some or all of the solids.

In the above described process for drilling oil or gas wells, it has been a standard practice to erect what is known in the art as a “reserve pit” for storing formation cuttings as well as drilling mud and water spills which occur during the drilling operation. These waste water spills from oil and gas well drilling operations consist of any of a number of undesirable compositions and may include such things as paraffins, oils, waste muds, wash down waters from the drilling rig itself, produced waters from the well, fracturing fluid flow back waters, and the like.

Reserve pits vary in size depending on the depths of the well to be drilled and the length of drilling time anticipated. During the drilling operation, all the fluid spills, regardless of their nature, are typically captured and stored in the reserve pit and allowed to accumulate until drilling is completed. These collected fluids have, in the past, been disposed of in various manners such as pumping into trucks for removal to dumping sites such as landfills, burning, or various other types of treated or untreated waste disposal. In fact, the dumping of the waste into streams and rivers has been a problem at times in the past.

At the present time, the customary equipment which may be present at the drilling site may include such things as a shale shaker, settling tanks, a shale bin for collecting solids for disposal, centrifuges and flocculent tanks. Certain applications of these pieces of equipment might be used in a process for treating reserve pit waste waters. However, these discrete pieces of equipment tend to be available as individual items that must be delivered to the well site in separate loads. It is necessary to choose compatible equipment that is interconnectable and that is properly sized to be of appropriate capacity to work with other selected equipment. Once delivered to the site, the various pieces of equipment must be assembled together. These tasks require superior organization and scheduling skills to ensure the components of a waste treatment system are delivered in a timely manner to the work site and assembled into an efficient and reliable treatment system.

Additionally, the presently available technologies have proved to be less than satisfactory in treatment of reserve pit waste waters. The existing technologies which have been tried to various extents include membrane filtration technology, electrocoagulation with membrane technology and vacuum distillation, to name a few. While certain of these technologies produce an acceptably clean product on a laboratory size scale, they have generally proved to be uneconomical when scaled up for use in the treatment of land based oil and gas reserve pits.

Thus, there is a need for an improved method of treating reserve pit waste waters of the above type.

Preferably, such an improved treatment method will be capable of cleaning the waste waters constantly and continuously to remove undesirable waste materials from the waste waters as the drilling operation progresses rather than after the entire operation as is often presently the case. This would allow for a smaller reserve pit in most cases.

A need exists, therefore, for an improved method for treating oil and gas well drilling reserve pits containing drilling, completion and production waste waters which method produces water of a quality suitable for such tasks as make-up, rig wash down, down hole fracturing operations or discharge to ground meeting environmental laws.

A need also exists for such a method which is capable of being practiced on a continuous basis as opposed to existing, state of the art, batch processes.

A need also exists for such a method which produces an acceptable product at a price which is more economical than the existing technologies presently in use at well clean-up sites.

### SUMMARY OF THE INVENTION

The present invention is an improved method for treating the contents of a well drilling reserve pit for rendering the contents safe for environmental discharge or reuse. The method includes first passing the reserve pit contents through a preliminary solids separation process which produces a waste water stream from which large and heavy solid particles have been removed. Next, the waste water stream is passed through an ozonation pre-treatment process which coagulates contaminants in the waste water stream for more efficient removal in a subsequent flocculation step. After the ozonation step, the waste water is passed through a flocculation process to render the waste water of sufficient re-use quality for such tasks as make-up, rig wash down, down hole fracturing operations, as well as the possibility of discharging to ground meeting environmental laws.

The preliminary solids separation step can conveniently be accomplished by passing the reserve pit contents through a preliminary centrifugal solids separation apparatus.

The preferred ozonation pre-treatment pre-process includes a first ozone injection step which separates and accumulates free oils for belt skim removal and BOD reduction and a second ozone injection step which coagulates contaminants in the waste water stream for more efficient removal in a subsequent flocculation step.

The preferred flocculation process includes passing the waste water through three continuous flow/mix chambers. The majority of water pre-treatment chemicals and flocculents are added in the first of the three continuous flow/mix chambers. The second flow/mix chamber is used for continuing the flocculent mixing process and optional addition of liquid chemicals. The third flow/mix chamber is for the final mixing process of continuous flow and optional final addition of liquid chemicals and mixing to achieve full agglomeration of the flocculent for post-treatment filtration.

The most preferred method of practicing the invention includes a further flocculent filtration step after the continuous flow mixing. The flocculent filtration step can be carried out by centrifugal mechanical separation using a filter mesh in a rotary chamber to produce a filtered water stream and a waste filtrate stream. The filtered water stream from the flocculent filtration step is then passed to a post-treatment ozonation step to assist in additional coagulation of post-treatment residual chemicals and solids. After the post-treatment ozonation, the filtered water stream passes to a media filtration tank capable of collection, filtration and back flushing of post treatment residual and coagulated solids. In the final step, the filtered water from the media filtration tank passes to a bag filter mechanical filtration step to provide a filtered water discharge having an entrained solids level which meets a desired standard, typically 100 microns or less.

Additional objects, features and advantages will be apparent in the written description which follows.

### BRIEF DESCRIPTION OF THE DRAWINGS

FIG. 1 is a schematic flow diagram of the process of the invention.

### DETAILED DESCRIPTION OF THE INVENTION

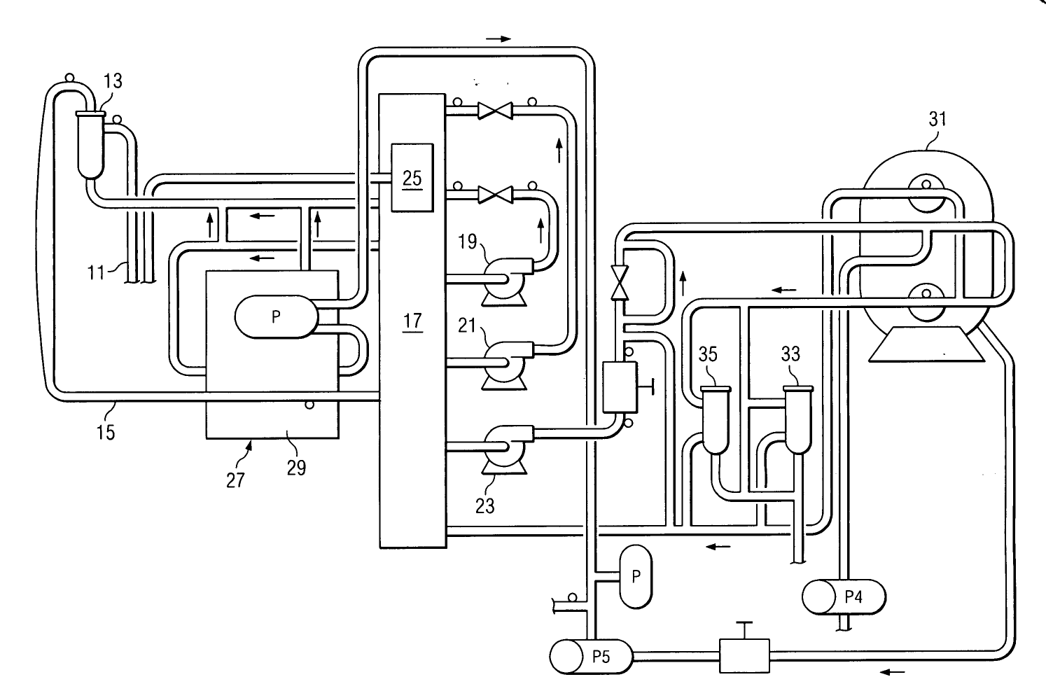

FIG. 1 is a flow diagram showing the principle components and steps in the process of the invention. The inventive method comprises a continuous process of portable system design for treating oil and gas well drilling, completion, and production waste waters to a re-use quality for make-up, rig wash down, or down hole frac operations, similar tasks or discharge to ground meeting environmental laws. The components of the system have previously been installed within two fifty three feet long enclosed container tractor trailers for delivery to the well site. The system can be supplied complete with all treatment equipment, an office, storage, maintenance, a restroom, and a power plant with fuel storage.

Turning to FIG. 1, waste water is pumped into the equipment trailer from a high volume portable pump (not shown) at the waste water source by manual operation or on demand control. Upon entering the equipment trailer through the inlet 11, the waste water enters a centrifugal separation pre-treatment unit 13 for initial solids removal of large or heavy particles centrifugally separated and removed from the waste water source. Solids are returned to the source or mechanically removed for periodic disposal.

From the centrifugal separation unit 13, the waste water stream passes through a flow conduit 15 to a mix tank 17 for an ozonation pre-treatment process and a subsequent flocculation process. The preferred ozonation pre-treatment is carried out in a first zone of the mixing tank 17 made up of one elongated chamber with oil separation and skimming capabilities. At two points in the chamber, waste water is recirculated through a venturi with the injection of ozone. Ozone injection pumps 19, 21, 23 create the venturi effect, pulling out liquid and then re-injecting ozonated water, typically at a rate on the order of 120 gallons per minute. The initial ozone injection processes carried out in the first half of the chamber is for the separation and accumulation of free oils for belt skim removal and BOD reduction. A skimmer unit is shown as 25 in FIG. 1. The second ozone injection processes carried out in the second half of the chamber is for the coagulation of contaminants in the waste water for efficient flocculation removal in a subsequent flocculation step. The ozonation processes can be monitored and regulated through an automatic control system.

Flocculation is achieved in three continuous flow mix chambers located in the mixing tank 17. The first flocculation chamber is where the majority of the water pre-treatment chemicals and flocculent are added. The initial hydration and mix of the flocculent is added in this chamber to begin the flocculation process of colloidal treatment. The colloidal treatment is typically accomplished with polymerized bentonite clay blends or combinations with hydrated polymer concentrates and pH adjustment chemicals.

The second flocculation chamber is for the continuation of the flocculent mix process. It is adjusted from slow fold to high speed mixing, depending on the loading of the waste water and nature of the treatment chemicals being added, which will only be liquid chemicals in the second chamber.

The third flocculation chamber is for the final process of the continuous flow hydration and mixing. The mix settings on the third chamber achieve final agglomeration of the flocculent for post-treatment filtration. Liquid treatment is possible in the third chamber as a final step of flocculent binding consistency.

After continuous flow mixing in the mix tank 17, flocculent filtration is carried out by means of centrifugal mechanical separation in drum (cylinder) filter 27. The preferred drum filter 27 is comprised of filter mesh located in a rotary chamber. The water enters a revolving mesh lined cylinder allowing the filtered water through with the filtrate exiting the opposite end of the cylinder for collection and disposal. The filtered water is collected in the base of the unit 27 for automatic pump off to the next treatment step. The reservoir 29 serves as an inlet and mix point for additional post-treatment chemical addition for the treated water through automatic adjustment. For example, chemicals might be added for pH adjustment in the reservoir tank 29.

The waste water from the flocculent filtration step passes to a post-treatment ozonation step to assist in additional coagulation of post-treatment solids which are too small to be filtered by the cylinder filter 27. The waste water is then post filtered in a media filtration tank 31 capable of collection, filtration, and back flushing of post-treatment residual and coagulated solids. The vessel 31 is preferably a carbon pod filter unit containing various treatment media such as activated charcoal, clays or other post-treatment media.

Post-treatment mechanical filtration by means of one or more bag filtration units 33, 35 is the last standard phase of treatment to assure a predetermined minimum filtration discharge range in microns of treated water. Typically this will be on the order of 100 microns or less.

Optional chloride reduction with membrane technologies can also be utilized for additional post-treatment as well as filtrate solidification, where desired.

An invention has been provided with several advantages. Applicant's treatment method has surpassed competitive technologies with portable ease of operation, undisputable treated water quality, continuous operation capability and a cost per barrel affordability for operators, unlike the technologies of the past. Colloidal technology using bentonite clay has been tried in the oil field in the past. Until now, however, it has never been affordable, as a cost per barrel of treatment to use for production or completion waste waters due to the amounts of clay necessary for treatment and the residual effects of treated water. Applicant's technology is mobile and can be moved from site to site in about two hours or less. The operating unit is designed to operate 24/7 and can be stationary at a central site with waste water brought to it from numerous pits or sites for treated water storage or spotted at a site and pumped through flexible pipelines to storage at another site or lagoon. In an active field with many drilling and completion operations going on at once, reserve pits, completion fluids or produced waters can be treated and piped directly to frac operations. Specific waste water treatment can be targeted for final water qualities needed, for example, in calcium chloride reduction. Water qualities can now affordably be met for complete waste water re-use with realistic and safe solids bi-product disposal. Applicant's unique ozonation pre-treatment acts to stabilize the molecular structure of the various contaminants present in the waste waters so that they more easily go into a coagulated state during the flocculation process. As a result, less clay is required, thereby improving the economics of the treatment process.

While the invention has been shown in only one of its forms, it is not thus limited but is susceptible to various changes and modifications without departing from the spirit thereof.

What is claimed is:

1. A method for treating contents of a well drilling reserve pit for rendering the contents safe for environmental discharge or reuse, the method comprising the steps of:
passing the reserve pit contents through a preliminary solids separation process which produces a waste water stream from which large and heavy solid particles have been removed;
passing the waste water stream through an ozonation pre-treatment process which coagulates contaminants in the waste water stream for more efficient removal in a subsequent flocculation step;
after the ozonation step, passing the waste water through a flocculation process to render the waste water of sufficient re-use quality for make-up, rig wash down or down hole fracturing operations.

2. A method for treating oil and gas well drilling, completion and production waste waters making up the contents of a well drilling reserve pit for rendering the contents safe for environmental discharge or reuse, the process comprising the steps of:
passing the reserve pit contents through a preliminary centrifugal solids separation process which produces a waste water stream from which large and heavy solid particles have been removed;
passing the waste water stream through an ozonation pre-treatment process, the pre-treatment ozonation process including a first ozone injection step which separates and accumulates free oils for belt skim removal and BOD reduction and a second ozone injection step which coagulates contaminants in the waste water stream for more efficient removal in a subsequent flocculation step;
after the ozonation process, passing the waste water through a flocculation process to render the waste water of sufficient re-use quality for make-up, rig wash down or down hole fracturing operations, the flocculation process including passing the waste water through three continuous flow/mix chambers.

3. The method of claim 2, wherein the majority of water pre-treatment chemicals and flocculents are added in the first of the three continuous flow/mix chambers, wherein the second flow/mix chamber is used for continuing the flocculent mixing process, and wherein the third flow/mix chamber is for the final process of continuous flow and hydration mixing to achieve final agglomeration of the flocculent for post treatment filtration.

4. The method of claim 3, further comprising a flocculent filtration step after the continuous flow mixing, the flocculent filtration step being carried out with a centrifugal mechanical separation using a filter mesh in a rotary chamber to produce a filtered water stream and a waste filtrate stream.

5. The method of claim 4, wherein the filtered water stream from the flocculent filtration step is passed to a post-treatment ozonation step to assist in additional coagulation of post-treatment solids.

6. The method of claim 5, wherein the filtered water stream passes from the post-treatment ozonation step to a media filtration tank capable of collection, filtration and back flushing of post treatment residual and coagulated solids.

7. The method of claim 6, further comprising the step of passing the filtered water from the media filtration tank to a bag filter mechanical filtration step to provide a filtered water discharge having an entrained solids level of 100 micron or less.
